(19) United States
(12) Patent Application Publication
(10) Pub. No.: US 2026/0361440 A1
(43) Pub. Date: Nov. 12, 2026

(54) PROGRAMMABLE WAVELENGTH SHARING IN OPTICAL NETWORKS

(71) Applicant: CISCO TECHNOLOGY, INC., San Jose, CA (US)

(72) Inventors: Randy ZHANG, Manassas, VA (US); Emerson Luis de Campos MOURA, São Paulo (BR); Maurizio GAZZOLA, Milano (IT)

(21) Appl. No.: 19/201,325

(22) Filed: May 7, 2025

(51) Int. Cl. H04J 14/02; H04Q 11/00

(52) U.S. Cl. CPC H04J 14/0202; H04J 14/0227; H04Q 11/0005; H04Q 2011/0016

(57) ABSTRACT

In one embodiment, a system includes a plurality of transponders and a programmable wavelength sharing (PWS) device having an M:N switch, wherein M is much greater than N. The system further includes a PWS device configured to share a plurality of wavelengths among a set of clients on the client side of the plurality of transponders and dynamically connect the set of clients to an optical network using the plurality of transponders. The set of clients are connected to the optical network with gray signals and colored signals using the plurality of wavelengths.

### FIELD

The present disclosure relates to optical networks, such as dense wavelength division multiplexing (DWDM) networks and, more particularly, to wavelength sharing for managing wavelength allocation and distribution in optical networks.

### BACKGROUND

The statements in this section merely provide background information related to the present disclosure and may not constitute prior art.

DWDM networks are optical networks in which optical signals at different wavelengths share an optical fiber. Each wavelength defines a particular communication channel. For communication to be established between the source of the communication and its destination in an electronic network that includes network nodes, a path is selected through the network nodes. The network path is determined by the electronic control plane. Different electronic control plane technologies can be used. However, unlike electronic networks, within a DWDM network, both a physical path of a communication and its wavelength are used for establishing the communication channel.

### DRAWINGS

In order that the disclosure may be well understood, there will now be described various forms thereof, given by way of example, reference being made to the accompanying drawings, in which:

FIG. 1 is a block diagram representation of an optical network in which programmable wavelength sharing may be implemented in accordance with various embodiments;

FIG. 2 is a block diagram illustrating a programmable wavelength sharing (PWS) device implemented in an optical network in accordance with various embodiments;

FIG. 3 is a block diagram illustrating a PWS device controller in accordance with various embodiments;

FIG. 4 is a block diagram illustrating a process flow for programmable wavelength sharing in accordance with various embodiments; and

FIG. 5 is a block diagram of a computing device in accordance with various embodiments.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features. As used herein, the term “module” refers to any hardware, software, firmware, electronic control component, processing logic, and/or processor device, individually or in any combination, including without limitation: application specific integrated circuit (ASIC), a field-programmable gate-array (FPGA), an electronic circuit, a processor (shared, dedicated, or group) and memory that executes one or more software or firmware programs, a combinational logic circuit, and/or other suitable components that provide the described functionality.

### Overview

As will be discussed in more detail herein, systems, methods, and computer program products are provided for programmable wavelength sharing. In various embodiments, a system includes a plurality of transponders; a programmable wavelength sharing (PWS) device having an M:N switch, the PWS device on a client side of the plurality of transponders; and a PWS device configured to share a plurality of wavelengths among a set of clients on the client side of the plurality of transponders and dynamically connect the set of clients to an optical network using the plurality of transponders, wherein the set of clients are connected to the optical network with gray signals and colored signals using the plurality of wavelengths.

### Example Embodiments

With the increased use of artificial intelligence (AI) training clusters spreading into multiple data centers, the demand for high-bandwidth network interconnects of compute nodes between data centers for the duration of the model training is increasing. Depending on the model size and other requirements, this demand may last for days, weeks, or months, but is not permanent. Accordingly, it is desirable to provide improved methods and systems, such as for use by communication service providers, to leverage existing optical transport networks to deliver the bandwidth on demand with flexible connectivity options. Any transponders that are not used for cross-connects can be powered down to save energy. Furthermore, other desirable features and characteristics of the present disclosure will become apparent from the subsequent detailed description and the appended claims, taken in conjunction with the accompanying drawings and the foregoing technical field and background.

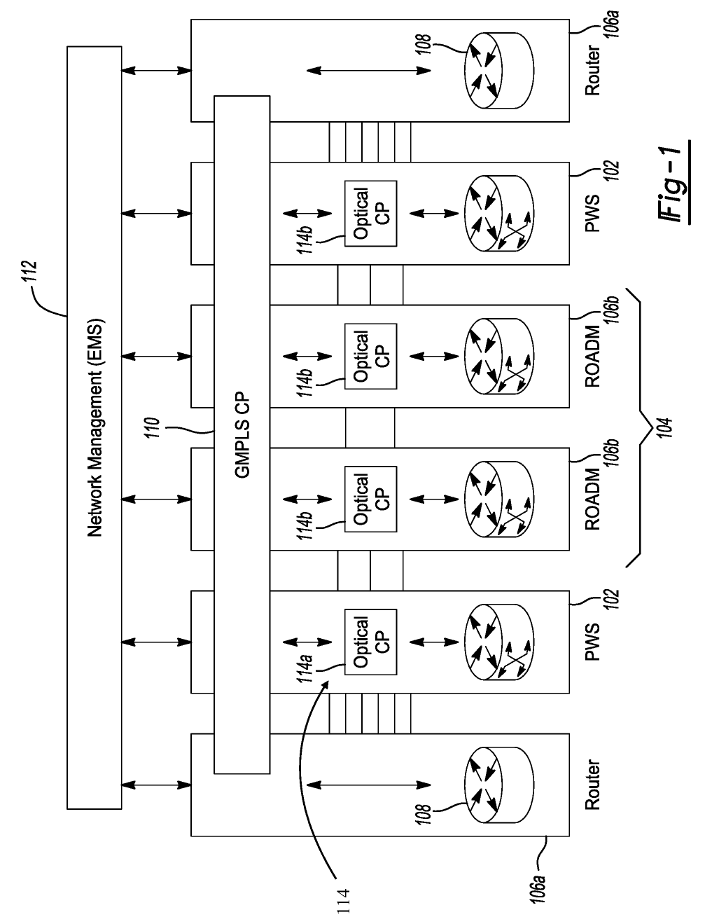

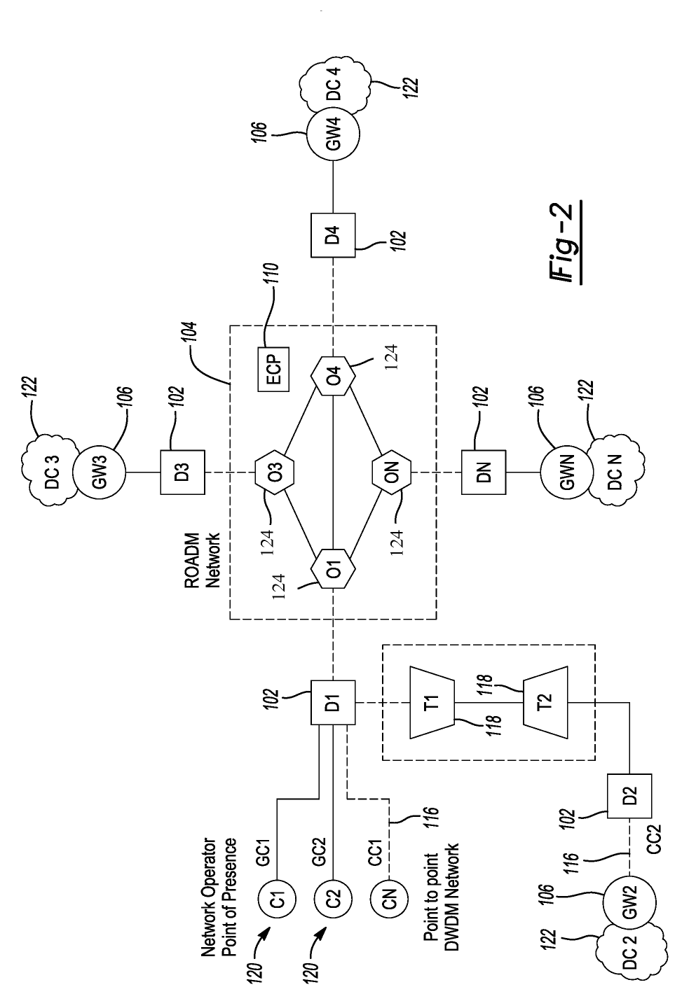

With reference to FIGS. 1 and 2, a system 100 is shown that includes a PWS device 102 in accordance with one or more embodiments. The PWS device 102 are configured to perform on-demand programmable wavelength sharing, and in one or more examples is deployed between an optical Reconfigurable Optical Add-Drop Multiplexer Network (ROADM) network 104 and customer data center gateway nodes 106 (also referred to as nodes 106) on the client side, enabling flexible and efficient bandwidth allocation. The PWS device 102 is configured to provision or change cross-connections on-demand or dynamically as described in more detail herein (e.g., using software via a PWS device controller).

In the illustrated example, the system 100 is an optical network in which an optical control plane (OCP) 114 (illustrated as having OCP 114a, 114b) is distributed across and embedded into the nodes 106 of the optical network with the nodes and the PWS device 102 providing the integration of the optical switching on the client side of the transponder to dynamically share the DWDM interfaces. That is, the PWS device 102 provides a dynamic programmable demarcation between clients and destination data centers, namely decoupling the clients from the DWDM interfaces. Additionally, the client interface can be gray and colored signals to support traditional and Routed Optical Networking (RON) use cases. As a result, network operators have greater flexibility in traffic mapping. And, centralized control or orchestration facilitates making the routing selection and resource reservation based on the data demand (e.g., customer data demand). As such, with M being much greater than N in an M:N switch structure, wavelength resources can be shared among many clients.

It should be noted that "gray" and "colored" signals refer to the type of optical wavelengths used. Gray wavelengths are non-DWDM client signals for short-reach connectivity to transponders while colored wavelengths are DWDM signals that can be directly connected to ROADM without transponders. It should also be noted that while an electronic network control plane 110 is illustrated as a Generalized Multi-Protocol Label Switching (GMPLS) CP, this is merely an example, and various embodiments can be used with different optical control planes.

The system 100 in some examples includes the optical network configured as a WDM network that includes the nodes 106. The nodes 106 may generally include router nodes 106a and add/drop nodes 106b. The add/drop nodes 106b may be, in one embodiment, Optical Add/Drop Multiplexers (OADMs) such as ROADMs. In operation, with the OADMs, optical signals of one or more fixed wavelengths are dropped and/or added at nodes 106b, and with the ROADMs, the added and/or dropped wavelengths at a node 106b may be changed or reconfigured in accordance with various embodiments as described in more detail herein to provide programmable wavelength sharing. It should be appreciated that although ROADMs are described and shown in FIG. 1, the ROADMs are shown for illustration of an example implementation and should not be considered to be limiting.

In one or more embodiments using the optical network implemented by the system 100, routers 108 associated with the nodes 106a are arranged to handle electrical switching. The add/drop nodes 106b provide entry (add) and exit (drop) points to the optical network. Hence, the source and the destination nodes of a message in the network are generally add/drop nodes 106b. It should be noted that while only four add/drop nodes 106b are shown, the number of add/drop nodes 106b in the network may be varied. It should also be noted that arrows show that the router nodes 106a are connected to the add/drop nodes 106b, as well as other router nodes 106a.

The network connections between the nodes 106a and 106b may be relatively complex, and an electronic network control plane, illustrated as an electronic network control plane 110 operating under GMPLS, handles the routing of a message between some source and destination nodes 106b. On top of the electronic network control plane 110 is a network management system 112 (illustrated as an Element Management System (EMS)), is a management controller in some embodiments that handles the higher supervisory and control functions of the network.

The OCP 114, which includes OCP parts 114a and 114b, is physically distributed across nodes 106b of the optical network. The OCP 114 gathers optical parametric information on the elements of the network, such as gathering information on the network elements such as the add/drop nodes 106b, which affect optical signals passing through the network. The term “gathers” is generally used to include actions in which the OCP 114 is passive and receives network element optical information sent to the OCP 114.

The OCP part 114a in one or more examples receives the path route information from the electronic network control plane 110 and determines the optical feasibility of the path route using path route information. The OCP 114 also checks channel feasibility. Other OCP parts 114b do not receive path route information from the electronic network control plane 110. In operation, the PWS device 102 provisions or changes cross-connections on-demand or dynamically. That is, wavelength sharing is performed dynamically in accordance with one or more embodiments. For example, as described in more detail herein, a shared pool or subset of transponders and wavelengths can be dynamically assigned to a larger pool or set of clients (e.g., wavelengths are shared on top of the ROADMs).

In some examples, the OCP part 114a is selected according to the path route from the electronic network control plane 110 to be either near the source node or the destination node. It should be noted that the OCP 114 is located at the add/drop nodes 106b of the optical network. In contrast to the nodes 106b, the routers 108 at the nodes 106a regenerate, reshape and retime optical signals so that the functions of the OCP 114 are effectively not required at these switching nodes.

With reference now to FIG. 2, PWS devices 102 in accordance with one or more embodiments are shown in a network architecture. The PWS devices 102 (D1-DN) are configured to perform on-demand programmable wavelength sharing as described in more detail herein and shown deployed between the ROADM network 104 and gateway nodes 106 (illustrated as gateway nodes (GWNs) 106, which may be customer data center gateway nodes) of data centers 122 (DCs), enabling flexible and efficient bandwidth allocation. That is, various embodiments provide on-demand or dynamic programmable wavelength sharing to enable improved bandwidth allocation.

The PWS devices 102 allow M:N connectivity from the gateway nodes 106 (GW1-GWN) to the ROADM network 104, and a plurality of nodes 124 (O1-ON), managed by an Extended Control Plane (ECP), which may be implemented as the electronic network control plane 110. However, it should be appreciated that other types of connectivity are contemplated and may be implemented, such as, 1:1, 1:N, and 1+1 types of connectivity. The PWS devices 102 in one or more embodiments are configured to provide coherent connections 116 (CC1, CC2) directly or over add/drop devices 118 (T1, T2), which correspond to the add/drop nodes 106b in various embodiments (e.g., coherent connections can be provided either directly or through add/drop devices). The PWS devices 102 in some embodiments also connect gray clients 120 (using gray connection GC1, GC2) to the optical network by providing a transponder or muxponder function as described in more detail herein. In one or more embodiments, provisioning and telemetry of the PWS devices 102 are performed by a PWS device controller or the network management system 112 (in the illustrated embodiment). It should be noted that one or more control operations can be performed by the PWS device controller and/or the network management system 112 acting as a controller.

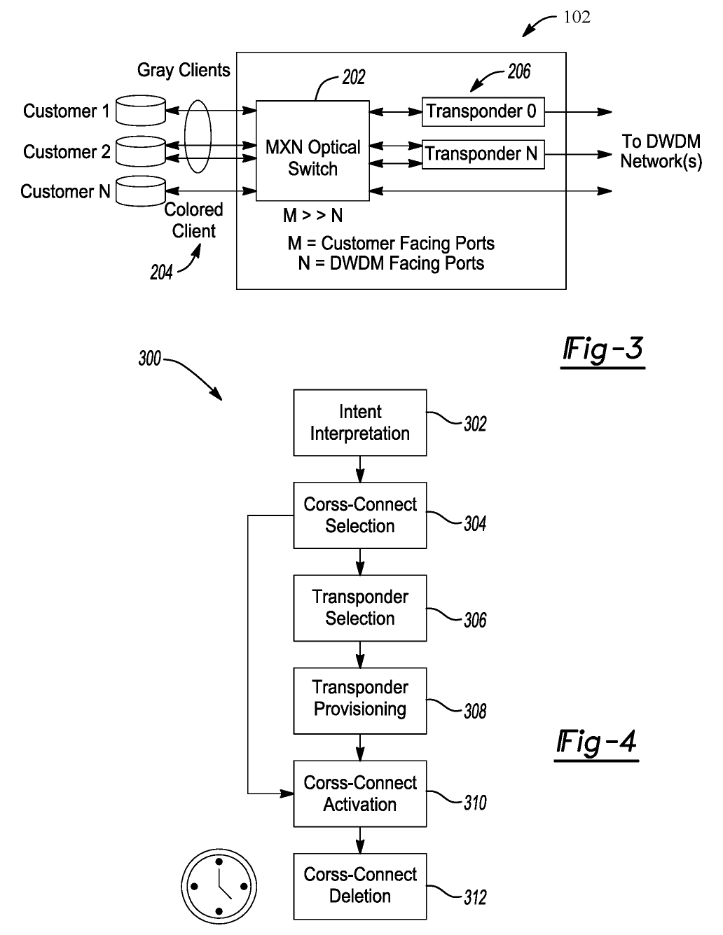

With reference to FIG. 3, in one or more embodiments, the PWS device 102 includes a switch 202, illustrated as an M:N optical switch. In one or more embodiments, the switch 202 provides colored and gray cross-connections between client signals 204 from a plurality of clients (e.g., a plurality of customers including signals from gray clients and signals from colored clients) and the optical network (e.g. the ROADM network 104) in a variety of ways. That is, various embodiments provide on-demand or dynamic cross-connecting using the switch 202, for example, with (1) a 1:1 direct connection between a colored port and a ROADM add/drop port, (2) a 1:1 connection through a transponder 206 between a gray client port and a ROADM add/drop port, or (3) M:1 connection through a muxponder between M gray client ports and one ROADM add/drop port.

In one or more embodiments, the cross-connections can be provisioned or changed on-demand through, for example, software via the PWS device 102 or the network management system 112 (illustrated as the EMS) as illustrated by the process flow 300 shown in FIG. 4. It should be noted that the various steps in the process flow can be performed in a different order and fewer or additional steps may be provided. Additionally, the various steps can be performed simultaneously, concurrently, or sequentially. In the illustrated example, a user or application (e.g., as part of a user interface configured to receive user inputs) is enabled to specify the intent of the cross-connect and interprets the intent and triggers the process flow 300.

In various embodiments, the intent is interpreted at operation 302. For example, the intent is interpreted into one or more of a type of cross-connect, transponder parameters if the cross-connect type is of transponders, and a duration of the cross-connect. That is, the type of cross-connect, transponder parameters, and/or duration of the cross-connect is identified based on the specified intent. A cross-connect type is then selected at operation 304. In one or more examples, a colored cross-connect bypasses the transponder selection and the process proceeds to cross-connect activation at operation 310. If a transponder is required, the type of transponder is determined in a transponder selection at operation 306. Then, the corresponding or correct type of transponder is provisioned at operation 308.

The cross-connect is then activated at operation 310 and the cross-connect enters into an operational stage, wherein dynamic telemetry will be triggered. The PWS device controller or the network management system 112 keeps track of at least the state and type of the cross-connect, what is provisioned and what is available, and when the cross-connect will expire. An expired cross-connect is automatically deleted at operation 312 and resources (e.g., optical signal paths) are released, for example, when reaching a time at which the cross-connect expires. In some examples, a deletion grace period may be added to allow extra margins of service (and the automatic deleting of the expired cross-connect occurs after the deletion grace period). It should be noted that if a transponder (e.g., the transponder 206) is not in use, the transponder can be powered down (turn off power to the transponder) until the transponder is used again to save power.

Using the process flow 300, in one or more embodiments, more efficient resource utilization and flexible connectivity in optical networks is provided. For example, the process flow 300 allows for establishing dynamic and programmable wavelength sharing in optical communication systems, as well as enabling flexible cross-connections between client signals and network infrastructure. For example, adaptable connectivity is provided as network demands fluctuate using the PWS devices 102 that can efficiently manage and provision optical resources, reduce power consumption, and facilitate real-time telemetry and provisioning (e.g., dynamic telemetry and provisioning). Additionally, the PWS device controller or the network management system 112 can automatically release resources after use and support various connectivity types, thereby enhancing operational efficiency and responsiveness in managing network traffic.

The PWS devices 102 is configured in various embodiments to provide M:N switching allowing for dynamic allocation of cross-connections between client signals and an optical network. The M:N switch enables, for example, flexible routing and allocation of bandwidth, allowing for efficient utilization of network resources by dynamically adapting to varying traffic patterns. The adaptable cross-connection arrangement facilitates compatibility with various wavelengths without the need for pre-configuration, enhancing the scalability and ease of integration into existing optical networks. The PWS devices 102 allow for seamless integration with existing optical networks and client signals in various embodiments to provide dynamic connectivity, enabling flexible and efficient cross-connections between various network components. In some examples, one or more embodiments allow for intuitive control and management for dynamic provisioning and telemetry having compatibility with and supporting a wide range of client interfaces and network architectures for enhanced interoperability.

As described in more detail herein, the various embodiments can be used in different applications or operating environments, such as being configured to establish M:N, connectivity between gateway nodes and a ROADM network. The capability to establish M:N connectivity provides a versatile solution for different levels of redundancy and service requirements, improving network reliability and user satisfaction. The integration with a ROADM network allows for seamless network expansion and reconfiguration, reducing operational costs and downtime associated with manual interventions in various embodiments.

In various embodiments, the PWS device controller or the network management system 112 allows for telemetry and provisioning of cross-connections on demand, wherein the telemetry enables real-time monitoring and analysis of network performance, which can result in proactive maintenance and optimization of the network. And, the controlled operation using transponders and muxponders for connections between gray client ports and ROADM add/drop ports facilitates the conversion between gray client ports and ROADM add/drop ports, enabling the integration of different signal types and enhancing the flexibility of the network architecture. In operation, the programmable wavelength sharing for performing telemetry and dynamic provisioning of the PWS devices 102 allows for automated network management, reducing the need for manual configuration and minimizing human error.

With the process flow 300, a control plane can be configured to interpret user intent into cross-connect parameters and facilitate cross-connect activation, which enhances the usability of the system by allowing for a more intuitive interface, thereby reducing the need for specialized technical knowledge to operate the system and leading to faster setup times and increased efficiency in network management. And, by reducing power consumption with powering down the transponder(s) 206 when not in use, energy savings can be achieved, which are both cost-effective and environmentally friendly. By minimizing power usage, one or more embodiments also reduce heat generation, which can prolong the lifespan of the transponder and decrease the need for cooling infrastructure, further reducing operational costs.

Thus, various embodiments allow for implementing a programmable wavelength sharing device that includes deploying the device between a reconfigurable optical add-drop multiplexer network and customer data center gateway nodes to enable dynamic bandwidth allocation. For example, the programmable wavelength sharing device (e.g., the PWS device 102) can be connected to a plurality of gateway nodes and optical network nodes through coherent connections, wherein an extended control plane is used manage connections from gateway nodes to the optical network nodes in various embodiments. The programmable wavelength sharing device enables 1:1, 1:N, and 1+1 connectivity options and enables an M:N switch in the programmable wavelength sharing device for dynamic cross-connection allocation between client signals and the optical network. A system for on-demand programmable wavelength sharing is thereby provided in one or more embodiments that includes a programmable wavelength sharing device positioned between a reconfigurable optical add-drop multiplexer network and data center gateway nodes, thus enabling improved dynamic and flexible bandwidth allocation. For example, one or more embodiments are configured to establish 1:1, 1:N, and 1+1 types of connectivity between gateway nodes and a reconfigurable ROADM network.

Programmable wavelength sharing is thereby performed in various embodiments. For example, one or more embodiments can use existing optical transport networks to deliver the bandwidth on demand with flexible connectivity options, such as for use with AI training clusters in multiple data centers. Thus, the programmable wavelength sharing in one or more embodiments addresses increased demand for high-bandwidth network interconnects of compute nodes between data centers for the duration of the model training.

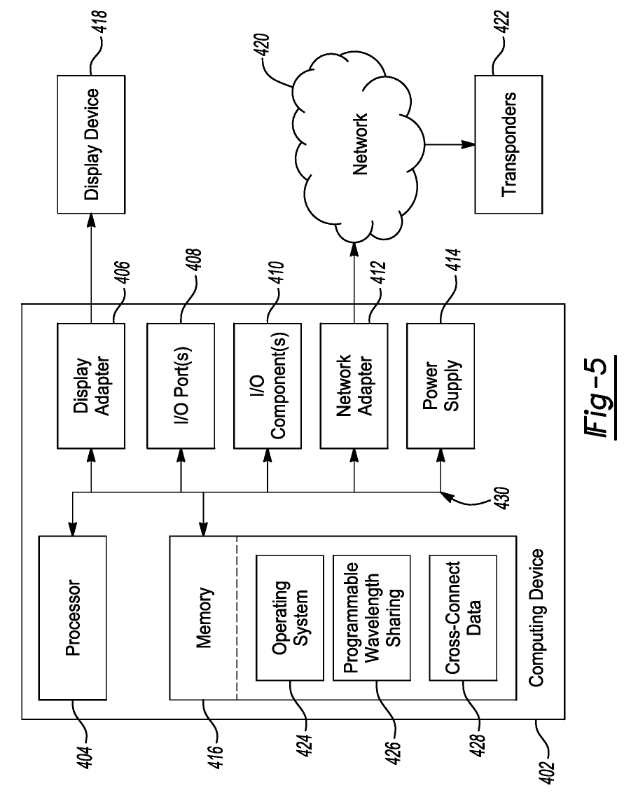

The systems and methods described herein, including the components, processors, servers, controllers. etc. (e.g., the PWS device 102) can be implemented on or in connection with a computing device 402 as illustrated in FIG. 5. For example, the computing device 402 can be a personal computer, a desktop, a laptop, a tablet, a hand-held computer, a server, a workstation, a mainframe, a wearable computer, a supercomputer, or a combination thereof. However, it is understood that the aforementioned examples of what the computing device 402 may be is non-exhaustive and that the computing device 402 can be any related device. The computing device 402 generally includes a processor 404, a display adapter 406, one or more input/output port(s) 408, one or more input/output component(s) 410, a network adapter 412, a power supply 414, and a memory 416. However, it is understood that the computing device 402 can include any additional components therein and is not required to include any of the listed components (e.g., the processor 404, the display adapter 406, the one or more input/output port(s) 408, the one or more input/output component(s) 410, the network adapter 412, the power supply 414, and the memory 416).

The processor 404 is configured to provide instructions and/or processing power to the computing device 402 so that the computing device 402 can process one or more tasks including the implementation of a software program. It is also understood that the computing device 402 may include any number or processors 404 therein. The display adapter 406 can be a graphics card or a video board that provides the computing device 402 with a capability to display content on a display device 418. For example, the display device 418 can be any screen, monitor, and/or light-emitting component associated with any of the personal computer, the desktop, the laptop, the tablet, the hand-held computer, the server, the workstation, the mainframe, the wearable computer, the supercomputer, or a combination thereof. However, it is understood that the aforementioned examples of what the display device 418 may be is non-exhaustive and that the display device 418 can be any related device.

The input/output port(s) 408 provides a number of sockets for one or more cables to connect to the computing device 402. It is understood that there may be any number of input/output port(s) 408 on the computing device 402. For example, the input/output port(s) 408 provides a means for the computing device 402 to receive signals and/or data from an external device connected to the computing device 402 via the one or more cables. As another example, the input/output port(s) 408 provides a means for the computing device 402 to send signals and/or data from an external device connected to the computing device 402 via the one or more cables. The input/output component(s) 410 can include one or more components that support the input/output port(s) 408 such as, but not limited to, a switch, a push button, a pressure mat, a float switch, a keypad, a radio receive, or a combination thereof.

A network adapter 412 can be a network interface controller that is configured to provide a means for communicating over a network 420 using one or more communication links 422 as described in more detail herein. The power supply 414 is configured to convert alternating high voltage current (e.g., AC) into direct current (e.g., DC) to provide regulated power to the other components (e.g., the processor 404, the display adapter 406, the one or more input/output port(s) 408, the one or more input/output component(s) 410, the network adapter 412, and the memory 416) of the computing device 402.

Additionally, the memory 416 can be a mass storage device and/or a system memory such as a hard disk drive, a memory card, a solid-state drive, random access memory (RAM), or a combination thereof. The memory 416 is configured to provide a holding place for instructions and data associated with the operation of the computing device 402. The memory 416 can generally include an operating system 424. For example, the operating system 424 is configured to perform programmable wavelength sharing 426 and/or process any of the data and/or instructions associated therewith using cross-connect data 428 to perform one or more operations as described in more detail herein.

Furthermore, a system bus 430 is also included within the computing device 402 that is configured to couple each of the various components (e.g., the processor 404, the display adapter 406, the one or more input/output port(s) 408, the one or more input/output component(s) 410, the network adapter 412, the power supply 414, and the memory 416) of the computing device 402. While the operating environment illustrated within FIG. 5 depicts a particular configuration associated with at least the computing device 402 and the network 420, it is understood that the operating environment may be configured in any way.

As used herein, the phrase at least one of A, B, and C should be construed to mean a logical (A OR B OR C), using a non-exclusive logical OR, and should not be construed to mean “at least one of A, at least one of B, and at least one of C.”

Unless otherwise expressly indicated herein, all numerical values indicating mechanical/thermal properties, compositional percentages, dimensions and/or tolerances, or other characteristics are to be understood as modified by the word “about” or "approximately" in describing the scope of the present disclosure. This modification is desired for various reasons including industrial practice, material, manufacturing, and assembly tolerances, and testing capability.

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, computer-readable storage medium (tangible medium) are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs and/or cause one or more processors to perform one or more particular functions. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A system, comprising:
a plurality of transponders;
a programmable wavelength sharing (PWS) device having an M:N switch, the PWS device on a client side of the plurality of transponders; and
a PWS device configured to share a plurality of wavelengths among a set of clients on the client side of the plurality of transponders and dynamically connect the set of clients to an optical network using the plurality of transponders, wherein the set of clients are connected to the optical network with gray signals and colored signals using the plurality of wavelengths.

2. The system of claim 1, wherein the PWS device is configured to connect between a Reconfigurable Optical Add-Drop Multiplexer Network (ROADM) network and a plurality of data center gateway nodes on the client side of the plurality of transponders, and the PWS device is configured to establish 1:1, 1:N, and 1+1 types of connectivity between plurality of data center gateway nodes and the ROADM network.

3. The system of claim 2, wherein the PWS device is configured to establish the connectivity between the plurality of data center gateway nodes and the ROADM network with (1) a 1:1 direct connection between a colored port and a ROADM add/drop port, (2) a 1:1 connection through a transponder of the plurality of transponders between a gray client port and a ROADM add/drop port, or (3) a M:1 connection through a muxponder between M gray client ports and one ROADM add/drop port.

4. The system of claim 1, wherein the set of clients include one or more gray clients and the PWS device is configured to connect the one or more gray clients to the optical network with a transponder of the plurality of transponders or a muxponder function.

5. The system of claim 1, wherein the PWS device is configured for dynamic telemetry and provisioning of cross-connections using the M:N switch.

6. The system of claim 1, further comprising a control plane or management controller for performing telemetry and dynamic provisioning of the PWS device.

7. The system of claim 6, wherein the control plane or the management controller is configured to interpret a user intent into one or more cross-connect parameters to perform cross-connect activation with the PWS device.

8. The system of claim 7, wherein the cross-connect parameters comprise a type of cross-connect, one or more transponder parameters, and a duration of the cross-connect.

9. The system of claim 7, further comprising a user interface enabling an application to receive an input corresponding to the user intent.

10. The system of claim 1, wherein the PWS device is configured to turn off power to a transponder of the plurality of transponders in response to a determination that the transponder is not in use.

11. The system of claim 1, wherein the PWS device is configured for coherent connections directly or through add/drop devices.

12. A method, comprising:
receiving a specified intent of a cross-connect for a plurality of transponders in an optical network;
identifying one or more of a type of cross-connect, one or more transponder parameters, and a duration of the cross-connect based on the received specified intent;
selecting a cross-connect from a plurality of wavelengths based on the identified type of cross-connect, the one or more transponder parameters, and the duration of the cross-connect;
selecting a transponder of the plurality of transponders to use for the cross-connect to a client of a plurality of clients;
provisioning the selected transponder; and
activating the cross-connect, wherein the cross-connect enters an operation stage that triggers a telemetry operation.

13. The method of claim 12, wherein a colored cross-connect bypasses a transponder selection and proceeds to activating the cross-connect.

14. The method of claim 12, further comprising enabling an application to receive the specified intent.

15. The method of claim 12, further comprising tracking at least a state and a type of the cross-connect, a provisioned resource and an available resource, and a time at which the cross-connect expires.

16. The method of claim 15, wherein in response to reaching a time corresponding to the time at which the cross-connect expires, automatically deleting the expired cross-connect and releasing one or more corresponding resources.

17. The method of claim 16, wherein automatically deleting the expired cross-connect occurs after a deletion grace period.

18. The method of claim 12, further comprising turning off power to a transponder of the plurality of transponders in response to the transponder not being in use.

19. A programmable wavelength sharing (PWS) system, comprising:
a shared pool of transponders;
a shared pool of wavelengths;
a programmable wavelength sharing (PWS) device configured to be dynamically assigned to a transponder of the shared pool of transponders and a wavelength of the shared pools of wavelengths; and
a PWS device configured to dynamically assign the PWS device to a client of a plurality of clients using the assigned transponder and the assigned wavelength, wherein the plurality of clients is connected to an optical network with gray signals and colored signals using the shared pool of wavelengths.

20. The PWS system of claim 19, wherein the PWS device comprises an M:N switch and the PWS device is on a client side of the shared pool of transponders.
